(19) United States
(12) Patent Application Publication
(10) Pub. No.: US 2008/0193259 A1
(43) Pub. Date: Aug. 14, 2008

(54) Laminated wheel lug nut

(76) Inventor: Ross S. Hill, Lansing, MI (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/705,324

(22) Filed: Feb. 12, 2007

(51) Int. Cl. F16B 37/14

(52) U.S. Cl. 411/533; 411/429

(57) ABSTRACT

A wheel lug nut having a laminated nut and an attached nose that is shaped to be interfitted with the nut seat of the wheel. In use, the nose centers both the lug nut relative to the wheel bolt it receives and the wheel relative to the axle hub. The laminated nut includes a plurality of conical disc springs enclosed in a cage. When properly tightened, the disc springs deform to impart additional gripping force on the wheel bolt. Accordingly, the laminated nut provides additional resistance to loosening, even when used with a non-ferrous wheel. In one embodiment, the nose is attached to the cage, for example, by snap-fitting onto the base of the cage. The wheel lug nut may also include a removable decorative cap that encloses and protects the cage and the wheel bolt. The decorative cap may be removably attached to the nose.

### BACKGROUND OF THE INVENTION

The present invention relates to wheel lug nuts and more particularly to a laminated wheel lug nut.

Lug nuts are used to secure the vehicle wheel to the vehicle axle hub. Conventional lug nuts differ from standard nuts in a variety of ways, but one of the most evident differences is that a lug nut typically includes a nose that is shaped to be fitted into the nut seat on the wheel. The nose helps to center the bolt in bolt hole of the wheel and also to center the wheel on the axle hub.

Conventional “solid body” lug nuts have a tendency to loosen over time as a result of the vibrational loads resulting from a variety of things, such as road conditions, sudden braking, and rapid acceleration. This loosening can lead to wheel imbalance and can increase the possibility of the wheel coming loose from the vehicle. To reduce the likelihood of vibrational loosening, it is known to introduce additional preload into the joint between the wheel and the conventional “solid body” lug nut. In some applications, a “step” is formed in the mounting face of the wheel to provide the joint with additional spring or stretch.

In recent years, the popularity of aluminum and other non-ferrous wheels has increased dramatically due to their aesthetic appeal and comparatively light weight. Preloading as described above does not work particularly well with aluminum wheels. Aluminum wheels typically require greater material thickness in the area where the lug nuts are mounted than the corresponding area in a steel wheel. As a result, it is typically impracticable to incorporate preloading, as described above, into aluminum and other non-ferrous wheels. Steel inserts have been used in an attempt to permit the use of preloaded lug nuts on non-ferrous wheels; however, the use of such inserts is not widespread because it results in higher costs and may weaken the wheels.

With the advent of the more stylized wheels, many wheel designs no longer utilize hub caps. Hub caps help to protect both the lug nut and the wheel bolt from corrosion induced by environmental factors. Corrosion of either the lug nut or the wheel bolt can make removal of the lug nut nearly impossible. Wheels lacking hub caps are therefore very susceptible to corrosion, and, consequently, the tendency for lug nut removal to be difficult. To address this concern, some solid lug nuts are adapted to receive a lug nut cap that can be fitted over the lug nut and bolt end after tightening. The cap shields the nut and bolt end from the environment to reduce the risk of corrosion.

As a result of the foregoing, there is a need for a wheel lug nut that may help to reduce the risk of vibrational loosening—even in the context of aluminum and other non-ferrous wheels. It would be desirable for any such wheel lug nut to include a mechanism to improve aesthetics and reduce the risk of corrosion in the absence of a hub cap.

### SUMMARY OF THE INVENTION

The aforementioned problems are overcome by the present invention wherein a laminated nut adapted for use as a wheel lug nut is provided. The laminated wheel lug nut includes a laminated nut and a nose configured to interface within the nut seat in the wheel. In one embodiment, the nose is manufactured separately and attached to the laminated nut. In this embodiment, the laminated nut may include a cage having an integrated rim for attachment of the nose to the laminated nut. The rim may be a plurality of arms adapted to be snap-fitted into a corresponding cage notch in the nose.

In one embodiment, the nose includes a lead-in portion that facilitates attachment of the nose to the cage. The lead-in portion may be an angled shoulder extending around the inner circumference of the nose adjacent the cage. The angled shoulder assists during assembly by automatically compressing or flexing the rim inwardly as the nose is pushed into place on the cage. This permits the rim to be fitted into the inner circumference of the nose without the need for separate action. Accordingly, the lead-in portion permits the nose to be installed simply by pushing it into position on the laminated nut.

In one embodiment, the laminated lug nut includes a lug nut cap. The cap surrounds and encloses the cage of the laminated lug nut as well as the wheel bolt of the axle hub to help protect them from the environment. In this embodiment, the laminate lug nut includes structure for receiving the decorative cap. In one embodiment, the structure may include threads extending around the outer circumference of the nose. In another embodiment, the structure may be an annual rib or an annual recess adapted to be snap-fitted or frictionally interfitted with the nose.

The present invention provides a laminated nut that is particularly well-suited for use as a wheel lug nut. The laminated nut includes a nose that is received into the lug nut recess of a wheel and helps to center the wheel bolt of the axle hub within the recess. The use of a snap-fitted nose facilitates manufacture, assembly and installation of the laminated wheel lug nuts. When the laminated lug nut is properly tightened, the disc springs undergo intended deformation that grips the bolt shaft and helps to reduce the likelihood of the lug nut loosening when subject to vibrational loads. For example, the laminated wheel lug nut may provide improved resistance to joint changes induced by heat, vibration and settling. The laminated lug nut of the present invention may be particularly beneficial in the context of aluminum and other non-ferrous wheels where conventional “preloading” is either impossible, infeasible or simply inadequate. Further, the lug nut cap of the present invention provides enhanced aesthetic appeal and environmental protection reducing the risk of corrosion of the wheel bolt which makes lug nut removal difficult.

These and other objects, advantages, and features of the invention will be readily understood and appreciated by reference to the detailed description of the current embodiment and the drawings.

### BRIEF DESCRIPTION OF THE DRAWINGS

FIG. 1 is a perspective view of a laminated lug nut.

FIG. 2 is a top view of the laminated lug nut of FIG. 1.

FIG. 3. is a cross-section of the laminated lug nut of FIG. 1 taken along line 3-3 of FIG. 2.

FIG. 4 is a cross-section of a laminated lug nut utilizing an alternative nose construction.

FIG. 5 is a perspective view of an alternative embodiment of a laminated lug nut utilizing a bulbous decorative cap.

FIG. 6 is a cross-section of the laminated lug nut of FIG. 5 taken along line 6-6 of FIG. 5.

FIG. 7 is a perspective view of the laminated lug nut of FIG. 5 with the decorative cap removed.

FIG. 8 is a perspective view of an alternative embodiment of a laminated lug nut utilizing a hexagonal decorative cap.

FIG. 9 is a cross-section of the laminated lug nut of FIG. 8 taken along line 9-9 of FIG. 8.

### DESCRIPTION OF THE CURRENT EMBODIMENT

A laminated lug nut in accordance with an embodiment of the present invention is shown in the figures and generally designated 10. The lug nut 10 generally includes a cage 12, a plurality of disc springs 14, and a nose 16. The disc springs 14 are stacked and held relative to each other by the cage 12. The nose 16 is attached to the base 18 of the cage 12 and is shaped to fit within the lug nut seat in the corresponding wheel (not shown). The laminated lug nut 10 may include a decorative cap 20 that surrounds the cage 12 and is secured to the outer circumferential surface 22 of the nose 16. The present invention is illustrated and described in connection with a laminated nut constructed generally in accordance with U.S. Pat. No. 6,015,253, issued to Mitts on Jan. 18, 2000. U.S. Pat. No. 6,015,253 is incorporated herein by reference. The present invention is, however, well-suited for use with other laminate nut constructions.

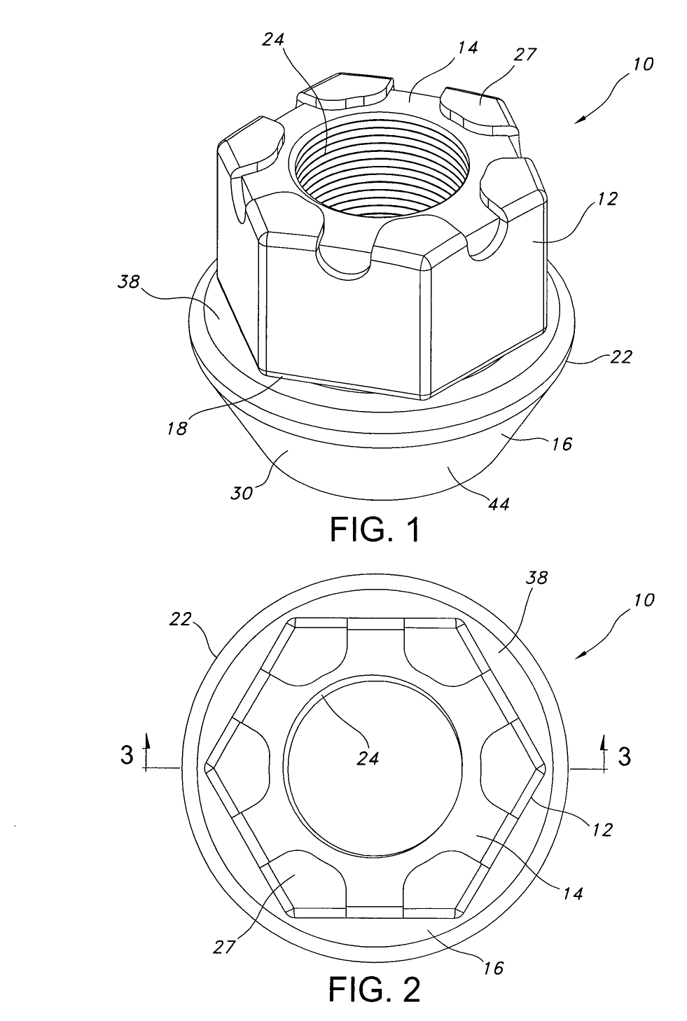

As noted above, the laminated lug nut 10 of FIG. 1 generally includes a cage 12, a plurality of disc springs 14 and a nose 16. The disc springs 14 are generally conventional and therefore will not be described in great detail. The disc springs 14 are stacked and enclosed within the cage 12. Each disc spring 14 defines a central bore 24. The central bores 24 of the disc springs 14 are in alignment with one another and are internally threaded. As a result, the central bores 24 cooperatively define a threaded through-bore that permits the laminated lug nut 10 to receive a threaded wheel bolt from the hub of a vehicle axle in essentially the same manner as a conventional solid lug nut. In one embodiment, the disc springs 14 are hexagonally shaped, but the springs may be shaped otherwise in alternative embodiments. The disc springs 14 have a somewhat truncated cone shape and are manufactured from elastically deformable material.

In the illustrated embodiment, the cage 12 is fabricated from a flat metal blank that is converted by a progressive die or some other forming method into a unitary elongated tube. The cage has a base 18 and tabs 27. The disc springs 14 are received into the cage 12, and the tabs 27 of the cage 12 are folded over to retain the discs 14. The cage 12 holds the disc springs 14 together in a stacked configuration and prevents them from rotating relative to each other.

The cage 12 may alternatively be constructed generally in accordance with U.S. Pat. No. 4,900,209, issued to Reynolds on Feb. 13, 1990. U.S. Pat. No. 4,900,209 is incorporated herein by reference. The cage 12 has a base 18 with a plurality of fingers extending from the base 18. The finger project up around the disc springs 14 with the ends of the fingers folding over onto the disc springs 14.

As noted above, the lug nut 10 includes a nose 16 shaped to be fitted into the lug nut seat of the wheel (not shown). In the illustrated embodiment, the nose 16 is separately manufactured and attached to the laminated nut 10 during assembly. In one embodiment, the cage 12 includes an annular nose channel 26 that extends from the base 18 of the cage 12 to receive the nose 16. The nose channel 26 terminates at an outwardly projecting nose retention rim 28. The nose channel 26 and retention rim 28 are shaped to be interfitted with corresponding structure on the nose 16 to intersecure the laminated nut 10 and the nose 16. In the illustrated embodiment the nose channel 26 and retention rim 28 are continuous; however, in alternative embodiments the channel 26 and/or the rim 28 may be segmented to facilitate assembly of the cage 12 with the nose 16. The material forming the nose channel 26 and the nose retention rim 28 is flexible and resilient to a degree that permits them to flex inwardly as necessary during installation of the nose 16 onto the laminated nut 10. Although the illustrated embodiment shows a flexible, resilient rim 28 for attaching the nose 16, the nose 16 may be attached to the laminated nut 10 using alternative structures, such as a threaded fitting or a bayonet-type fitting.

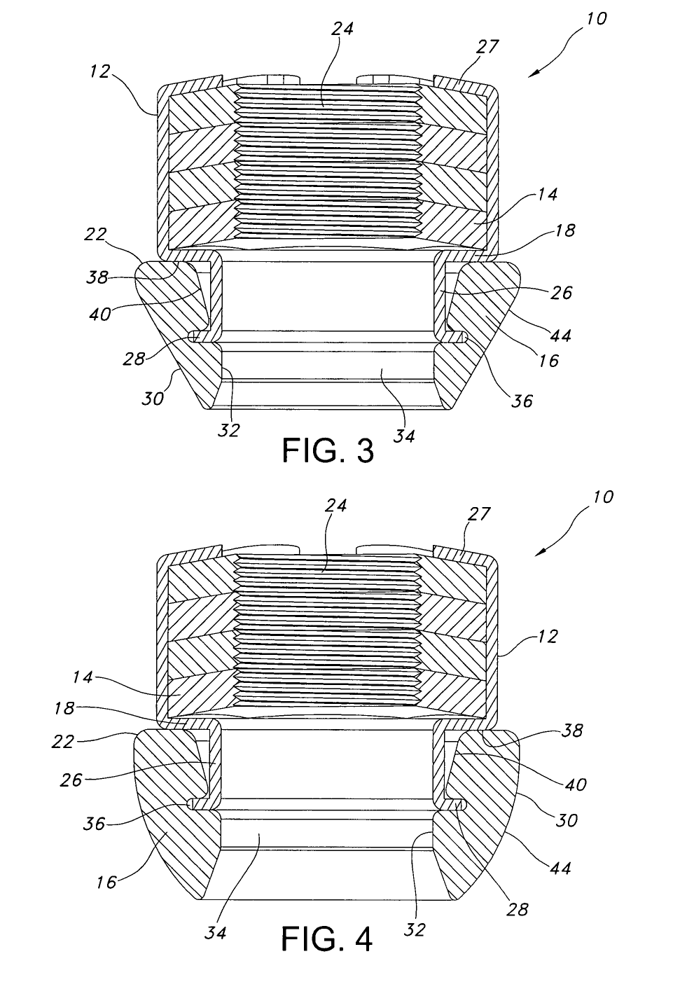

In the illustrated embodiment, the nose 16 is manufactured of solid steel or other suitable materials. The nose 16 includes an outer surface 30 that is configured to be closely fitted into nut seat in the wheel. As a result, the outer surface 30 of the nose 16 can take any geometry that may be incorporated into the nut seat of the wheel. For example, the outer surface 30 may be conical as in FIGS. 1 and 3 or spherical as in FIG. 4. The nose 16 defines a central bore 34 having an inner circumferential surface 32. The central bore 34 generally aligns with the central bores 24 of the disc springs 14 and the nose channel 26 of the cage 12 when the nose 16 is attached to the cage 12. The inner circumferential surface 32 defines a cage notch 36. In the illustrated embodiment, the cage notch 36 is an annular groove defined around the central bore 34 of the nose 16. The cage notch 36 is spaced from the cage interface surface 38 a distance approximately equal to the length of the cage nose channel 26. In this embodiment, the cage notch 36 receives the nose retention rim 28 of the cage 12 and is the mechanism by which the nose 16 is secured to the cage 12. In the illustrated embodiment, the inner circumferential surface 32 includes a lead-in portion 40 that facilitates installation of the nose 16 on the cage 12. The lead-in portion 40 of this embodiment is positioned between the cage interface surface 38 and the cage notch 36. The lead-in portion 40 is angled away from the central bore 34 as it rises from the cage notch 36 to the cage interface surface 38. The lead-in portion 40 facilitates assembly of cage 12 and nose 16 by guiding the retention rim 28 into the cage notch 36. More specifically, the lead-in portion 40 of this embodiment automatically compresses the retention rim 28 inwardly as the nose 16 is pushed onto the cage 12 so that the retention rim 28 fits into the central bore 34 of the nose 16. Once the nose 16 is pushed fully onto the cage 12, the retention rim 28 reaches the cage notch 36 and it springs outwardly to interlock with the nose 16.

The laminated lug nut 10 of the present invention is intended primarily for securing wheels to a vehicle. In use, a wheel is fitted over the wheel bolts on an axle hub. A laminated lug nut 10 is initially mounted onto each threaded wheel bolt in a generally conventional manner. In the initial untightened position, the disc springs 14 are in an undeformed condition and are still somewhat conical. The lug nut 10 is free running on the wheel bolt until the nose 16 is seated within the recess of the wheel. Seating the nose 16 within the nut seat in the wheel ensures the precise centering of both the wheel bolt within the wheel hole and the wheel relative to the axle. Additional tightening beyond this point compresses and partially flattens the disc springs 14. The deformation of the disc springs 14 generates a locking force on the wheel bolt that resists the tendency to become loose due to vibrational loads.

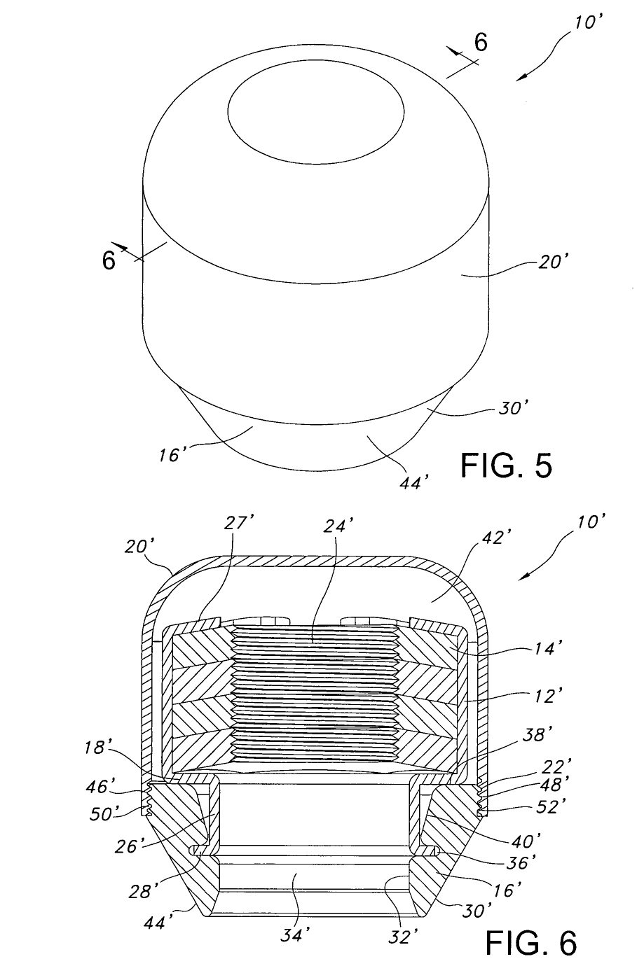

An alternative embodiment of the current invention including a decorative cap 20′ is shown in FIGS. 5-9 and designated generally 10′. This embodiment is substantially similar to the embodiments described above, except as otherwise described below. Although referred to as a “decorative” cap, it should be understood that the cap is not merely decorative and that it may reduce the likelihood of corrosion because it shields the wheel bolt and laminated nut 10′ from the environment.

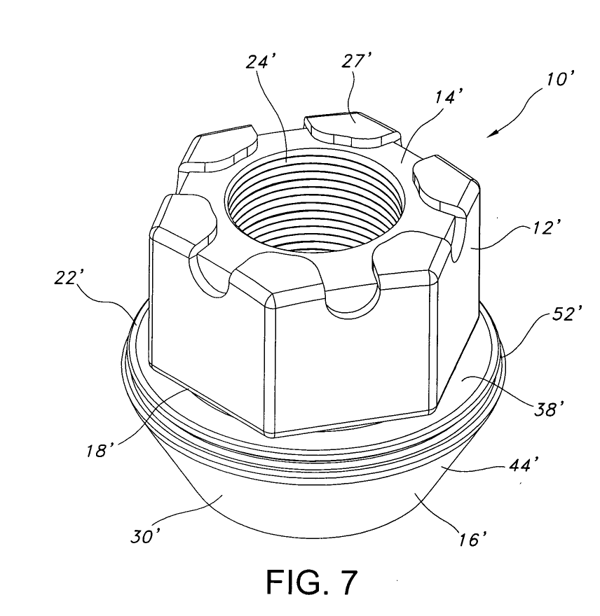

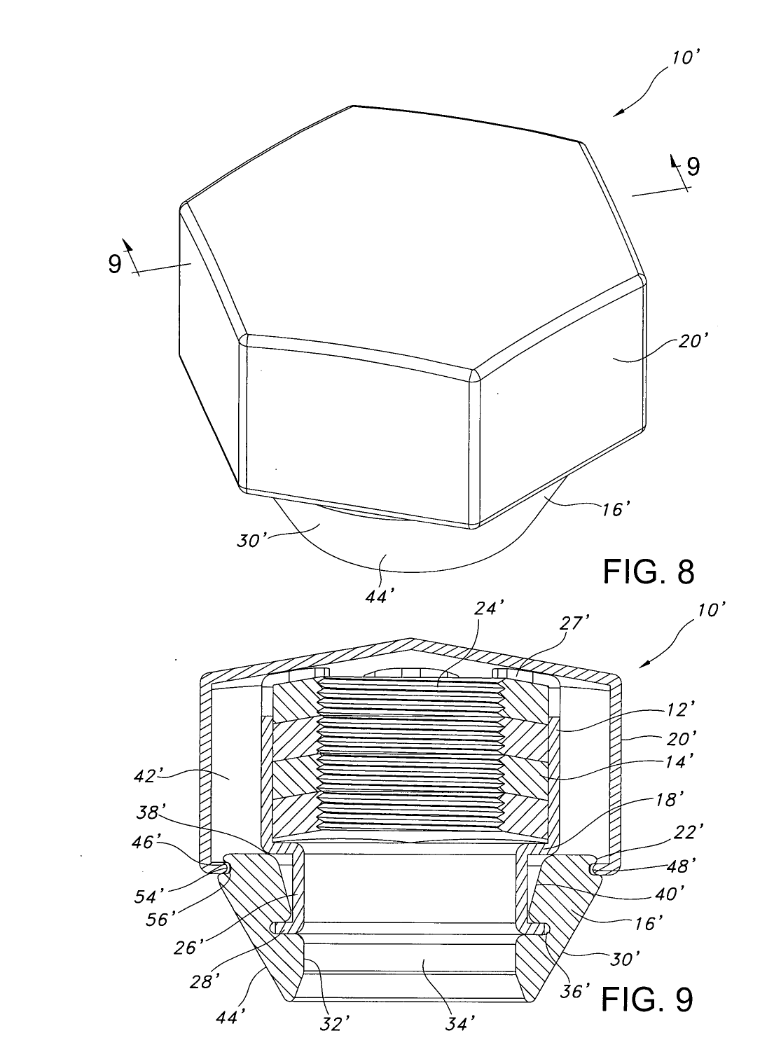

In the illustrated embodiment, the decorative cap 20′ surrounds the cage 12′ and is fastened to the outer circumferential surface 22′ of the nose 16′. The decorative cap 20′ defines an interior cavity 42′ that receives and surrounds the cage 12′ and the wheel bolt. The exterior surface 44′ of the nose 16′ can be any geometry providing the desired aesthetic effect including bulbous as seen in FIGS. 5 and 6 or hexagonal as in FIGS. 8 and 9. The cap 20′ can be constructed of any material providing suitable performance and aesthetics, including chromed metal, brushed steel or plated plastic. The nose interface 48′ may be located on the inner circumferential surface 46′ of the decorative cap 20′. In one embodiment, depicted in FIGS. 6 and 7, the nose interface 48′ includes a threaded region 50′ on the inner circumferential surface of the nose 16′.

In the illustrated embodiment, the nose 16′ includes structure for receiving the decorative cap 20′. As shown, the nose 16′ of FIGS. 5-7 includes threads 52′ extending around the outer circumferential surface 22′ of the nose 16′. The threaded region 50′ of the decorative cap 20′ interfaces with the nose threads 52′ to secure the cap 20′ to the nose 16′. In another embodiment, depicted in FIG. 9, the nose interface 48′ is a circumferential lip 54′. This circumferential lip 54′ can be interfitted with a groove 56′ on the outer circumferential surface 22′ of the nose 16′ to secure the decorative cap 20′. In alternative embodiments, the decorative cap 20′ may be permanently attached to either the nose 16′ or cage 12′ before or after installation of the lug nut 10′.

As should be evident from the alternative embodiments discussed above, the current invention is suitable for adaptation to various configurations of laminated lug nuts. The structure of the cage 12 can vary as the application dictates. The geometry and deformability of the disc springs 14 can be varied to induce the desired spring loading effect on the lug nut 10 and wheel bolt. The geometry of the nose 16 can be adjusted to accomplish varying performance goals including decreased weight or alternative aesthetics. Finally, the decorative cap 20 can interface with the nose 16 in alternative ways, and the exterior surface can be of any desired styling.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A laminated lug nut for a wheel comprising:
a plurality of conical discs, said discs each define a threaded central bore, said discs stacked on top of one another vertically with central bores in alignment;
a cage receiving said plurality of conical discs and holding said discs substantially rotationally stationary relative to one another; and
a nose attached to said cage, said nose being shaped to interface with a nut seat in a wheel.

2. The laminated lug nut of claim 1 wherein said nose defines a central bore, said central bore in alignment with said central bores of said discs when said nose is attached to said cage.

3. The laminated lug nut of claim 2 wherein:
said cage includes a base, a nose channel and a nose retention rim, said nose channel extends from said base, said nose retention rim extends from said nose channel; and
said nose defines a cage notch located in said central bore of said nose, said cage notch receives said nose retention rim when said nose is attached to said cage.

4. The laminated lug nut of claim 3 wherein said nose further defines a cage interface surface, said surface is adjacent to said base of said cage when said nose is attached to said cage, said nose also further defines a lead-in portion, said lead-in portion is located within said central bore extending from said cage notch up to said cage interface surface, said lead-in portion angling radially outward as it rises from said cage notch to said cage interface surface.

5. The laminated lug nut of claim 4 wherein said nose has an outer surface generally conical in shape.

6. The laminated lug nut of claim 4 wherein said nose has an outer surface generally semi-spherical shape.

7. The laminated lug nut of claim 1 further including a cap, said cap being permanently attached to at least one of said cage and said nose.

8. The laminated lug nut of claim 7 wherein said nose includes an externally threaded portion and said cap includes an internally threaded portion; and
wherein said cap is secured to said nose by threadedly interfitting said externally threaded portion and said internally threaded portion.

9. The laminated lug nut of claim 7 wherein said cap is snap-fitted onto said nose.

10. A laminated lug nut comprising:
a plurality of generally conical discs, said discs each defining a threaded central bore, said discs stacked vertically with said central bores in alignment;
a cage having a base, a nose channel and a nose retention rim, said nose channel extending from said base, said nose retention rim extends from said nose channel, said cage receiving said plurality of conical discs and holding said discs rotationally stationary relative to one another; and
a nose attached to said cage, said nose defines a central bore, said central bore of said cage in alignment with said central bores of said discs when said nose is attached to said cage, said nose also defines a cage notch located in said central bore of said nose, said cage notch receives said nose retention rim when said nose is attached to said cage, said nose also defines a cage interface surface, said surface is adjacent to said base of said cage when said nose is attached to said cage, said nose also further defines a lead-in portion, said lead-in portion is located within said central bore extending from said cage notch to said cage interface surface, said lead-in portion angles radially outward as it transitions from said cage notch to said cage interface surface.

11. The laminated lug nut of claim 10 wherein said nose is comprised of solid geometry.

12. The laminated lug nut of claim 10 wherein said nose has an outer surface at least one of generally conical in shape or generally semi-spherical in shape.

13. The laminated lug nut of claim 10 further including a cap, said cap being removably attached to at least one of said cage and said nose.

14. A laminated lug nut for a wheel having a nut seat comprising:
a plurality of conical discs, said discs each defining a threaded central bore, said discs stacked on top of one another vertically with central bores in alignment;
a cage, said cage defining an internal space receiving said plurality of conical discs, said cage holding said discs rotationally stationary relative to one another; and
a nose attached to said cage, said nose corresponding in shaped with the nut seat of the wheel.

15. The laminated lug nut of claim 14 further including a decorative cap removably attached to the laminated nut.

16. The laminated nut of claim 14 further including a decorative cap removably attached to said nose.

17. The laminated nut of claim 16 wherein said nose includes an externally threaded portion and said cap includes an internally threaded portion, said externally threaded portion being threadedly interfitted with said internally threaded portion to removably secure said cap to said nose.

18. The laminated lug nut of claim 17 wherein said decorative cap is snap-fitted onto said nose.

19. The laminated lug nut of claim 17 wherein said interior circumferential surface of said decorative cap includes a circumferential lip, said outer circumferential surface of said nose defines a groove, wherein said groove receives said lip when said decorative cap is fitted onto said nose.

20. The laminated lug nut of claim 14 wherein said cage includes attachment means for snap-fitting said nose onto said cage.
